(19) United States
(12) Patent Application Publication
(10) Pub. No.: US 2026/0037840 A1
(43) Pub. Date: Feb. 5, 2026

(54) HIGHLY INTERACTIVE, LANGUAGE MODEL-BASED NETWORK TROUBLESHOOTING AGENTS

(71) Applicant: Cisco Technology, Inc., San Jose, CA (US)

(72) Inventors: Eduard Schornig, Haarlem (NL); Grégory Mermoud, Venthône (CH); Pierre-André Savalle, Rueil-Malmaison (FR); Jean-Philippe Vasseur, Combloux (FR)

(73) Assignee: Cisco Technology, Inc., San Jose, CA (US)

(21) Appl. No.: 18/794,275

(22) Filed: Aug. 5, 2024

(51) Int. Cl. G06N 5/04

(52) U.S. Cl. CPC G06N 5/04

(57) ABSTRACT

In one implementation, a device obtains a prompt from a user interface that requests a network troubleshooting agent complete a task with respect to a computer network using one or more language models. The device identifies, using the network troubleshooting agent, a series of steps for the network troubleshooting agent to perform in order to complete the task. The device uses the network troubleshooting agent to perform the series of steps using the one or more language models. The device provides update information to the user interface regarding performance of one or more of the series of steps by the network troubleshooting agent.

### TECHNICAL FIELD

The present disclosure relates generally to highly interactive, language model-based network troubleshooting agents.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

However, as an agent refines its plan and performs the steps of that plan, a considerable amount of time may have elapsed between the time at which a user issued the original query and when the agent returns a final answer (e.g., on the order of minutes). This amount of time can also vary, depending on the complexity of the task, the number of steps that the agent has to perform, how long an API call takes to complete, and the like. From the perspective of the user, this uncertainty and delay may be unacceptable.

In addition, the intermediate steps that the agent takes to produce its answer may also be hidden from the user, which could lead the user to distrust any answers from the agent. For instance, in the case of the agent returning a generic answer, the user may be confused as to how or why the agent arrived at such a response. Further, the user may be left waiting for an answer without the ability to influence how the agent arrives at its answer.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example software defined network (SDN) implementation;

FIG. 5 illustrates an example architecture for using a large language model (LLM)-based troubleshooting agent in a computer network;

FIG. 6 illustrates the operation of an LLM-based network troubleshooting agent;

FIG. 7 illustrates an example of a time delay for an LLM-based network troubleshooting agent providing an answer;

FIG. 8 illustrates an example execution graph for an LLM-based network troubleshooting agent;

FIG. 9 illustrates an example of an LLM-based network troubleshooting agent that allows user collaboration to generate an answer; and

FIG. 10 illustrates an example simplified procedure for providing a highly interactive, language model-based network troubleshooting agent.

### DESCRIPTION OF EXAMPLE IMPLEMENTATIONS

### Overview

According to one or more implementations of the disclosure, a device obtains a prompt from a user interface that requests a network troubleshooting agent complete a task with respect to a computer network using one or more language models. The device identifies, using the network troubleshooting agent, a series of steps for the network troubleshooting agent to perform in order to complete the task. The device uses the network troubleshooting agent to perform the series of steps using the one or more language models. The device provides update information to the user interface regarding performance of one or more of the series of steps by the network troubleshooting agent.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

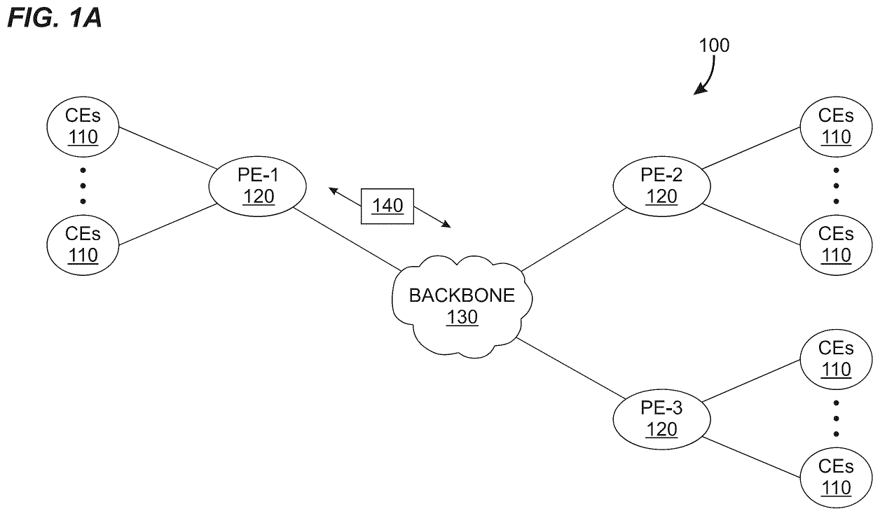

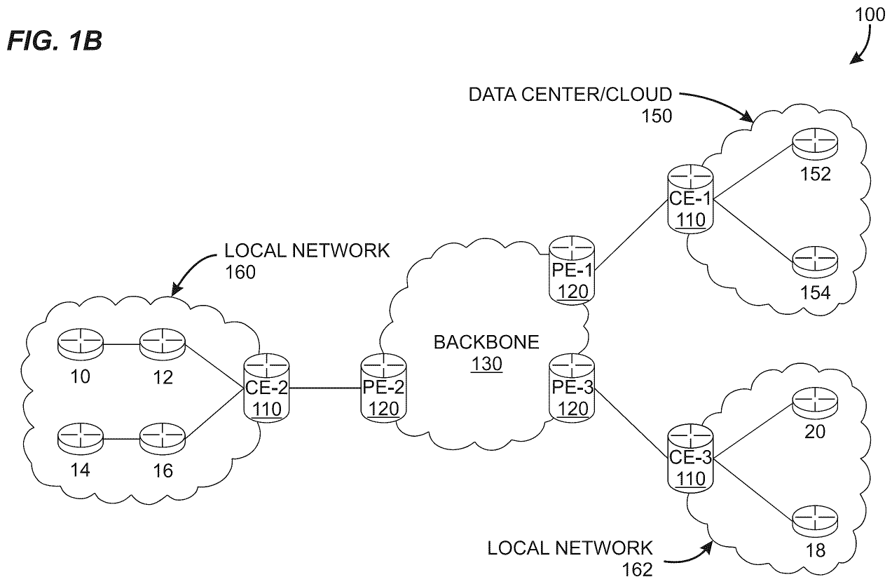

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

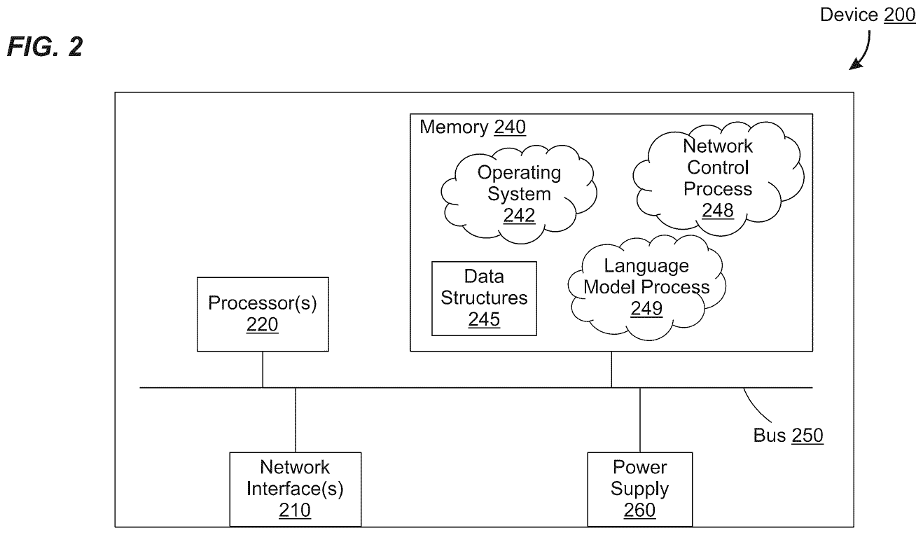

FIG. 2 is a schematic block diagram of an example node/device 200 (e.g., an apparatus) that may be used with one or more implementations described herein, e.g., as any of the computing devices shown in FIGS. 1A-1, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a network control process 248 and/or a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In some instances, network control process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, network control process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, network control process 248 and/or language model process 249 may include computer executable instructions that, when executed by processor(s) 220, cause device 200 to perform the techniques described herein. To do so, in some implementations, network control process 248 and/or language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, network control process 248 and/or language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network control process 248 and/or language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, network control process 248 and/or language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network control process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

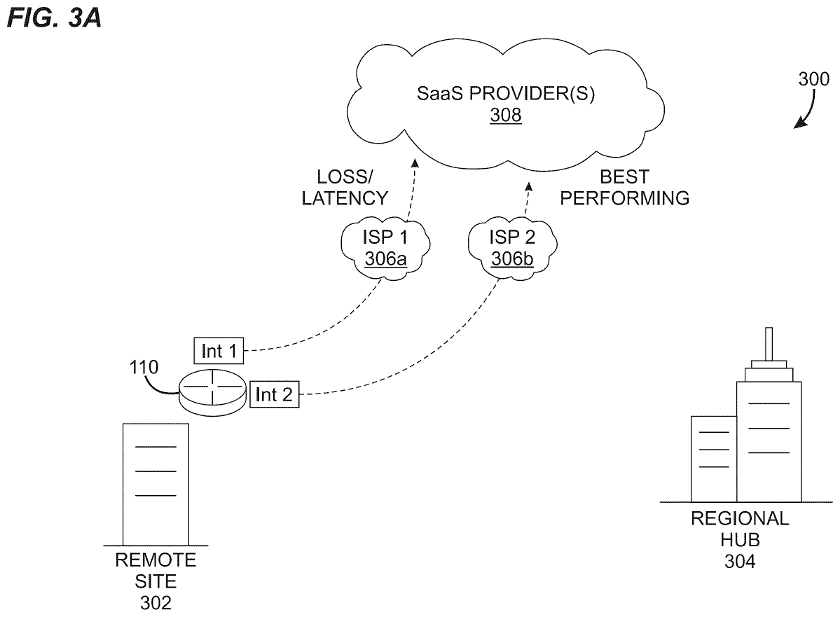

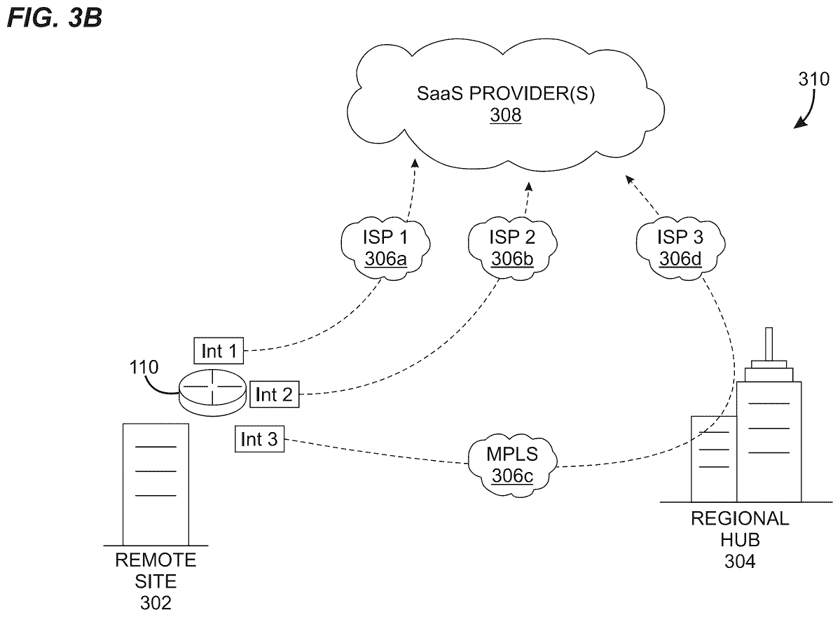

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

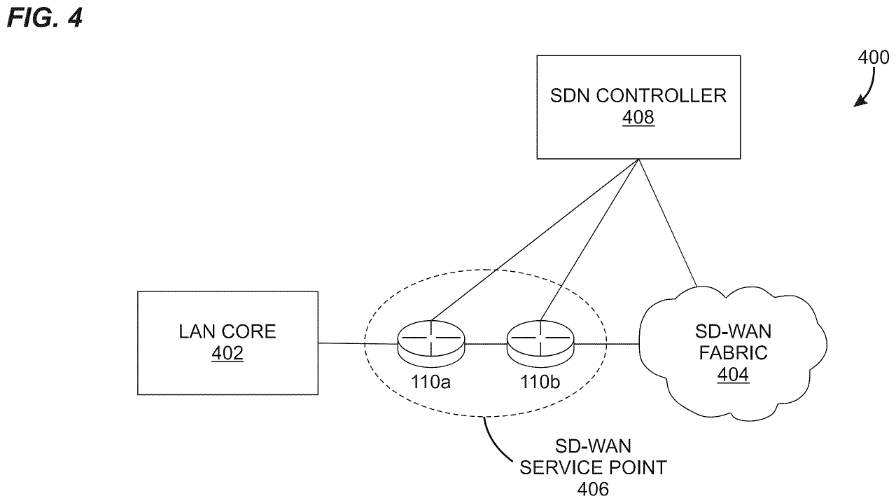

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., through execution of network control process 248), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words, SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications).

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The introduction of plugins is a major development that enables LLM-based agents to interact with external systems and empower new domain-specific use cases. In the context of communication networks, the utilization of plugins allows LLMs to engage with documentation repositories, tap into knowledge bases, and interface with live network controllers and devices potentially opening the path to LLMs undertaking more complex tasks such as on-demand troubleshooting, device configuration, and performance monitoring. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

However, building a user-facing product from an LLM-based agent can be difficult for reasons such as the following:
An agent flow to answer a question may require multiple steps, each of which can take some time, individually. Consequently, the system may take a noticeable amount of time to provide an answer to the original question (e.g., on the order of minutes), which can be frustrating to users.
LLMs can make mistakes which may not be apparent to a user. For example, consider the case of an LLM that can generate code that calls an API to list network devices but somehow provides an incorrect filter argument to the API. When the API returns an empty result set, a user may interpret this result as meaning that no devices match their desired criteria while, in fact, the system simply called the API incorrectly. These issues can be hard to avoid due to the opaque and non-deterministic nature of LLMs, and users may quickly lose confidence in the system when faced with such issues.
Although LLMs can provide an alternative user experience by allowing a user to ask questions about a system using natural language, users often have years of familiarity with traditional web or application user interfaces. A chatbot can feel like a disconnected experience from those user interfaces, which can also be frustrating to users.

The techniques herein introduce an LLM-based troubleshooting and monitoring agent that can be used to both troubleshoot an issue and trigger a set of actions in order to solve the issue. In some implementations, several conditions could be met for an issue to be eligible to self-healing, such as the criticality of the issues (determined by the volume of request sent to a bot for that issue). Various mechanisms are then used to determine whether the set of actions led to the resolution of the issue. Successful resolutions are then used to record successful troubleshooting trajectories and thus improve the training of the agent.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein, such as in conjunction with network control process 248.

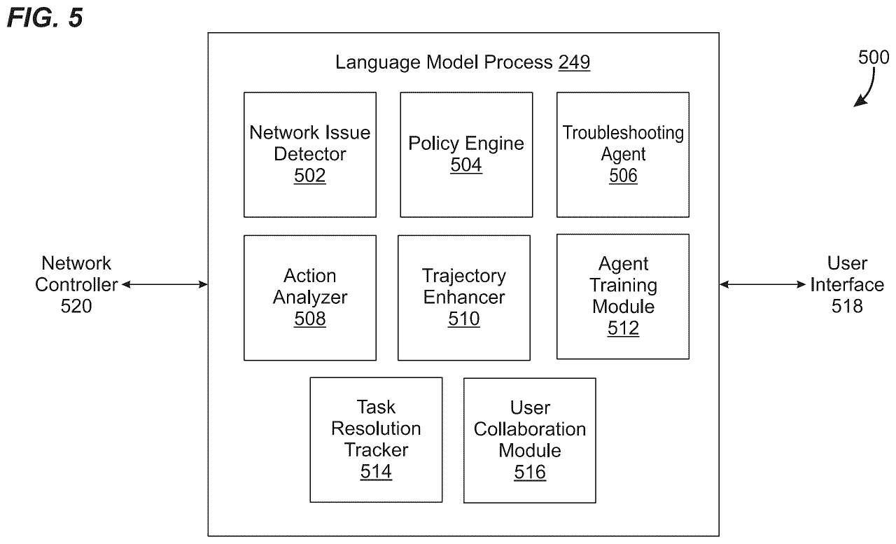

Operationally, FIG. 5 illustrates an example architecture 500 for using a large language model (LLM)-based troubleshooting agent in a computer network, according to various implementations. At the core of architecture 500 is language model process 249, which may be executed by a controller for a network or another device in communication therewith. For instance, language model process 249 may be executed by a controller for a network (e.g., SDN controller 408 in FIG. 4, a network controller in a different type of network, etc.), a particular networking device in the network (e.g., a router, a firewall, etc.), another device or service in communication therewith, or the like. For instance, as shown, language model process 249 may interface with a network controller 520, either locally or via a network, such as via one or more application programming interfaces (APIs), etc.

As shown, language model process 249 may include any or all of the following components: a network issue detector 502, a policy engine 504, a troubleshooting agent 506, an action analyzer 508, a trajectory enhancer 510, an agent training module 512, a task resolution tracker 514, and/or a user collaboration module 516. As would be appreciated, the functionalities of these components may be combined or omitted, as desired. In addition, these components may be implemented on a singular device or in a distributed manner, in which case the combination of executing devices can be viewed as their own singular device for purposes of executing language model process 249.

During execution, network issue detector 502 may detect an issue in a network and assess its criticality. To do so, network issue detector 502 may employ any number of modes for the issue detection. In one case, network issue detector 502 may explicitly list the set of issues eligible for self-healing functionality (e.g., detection of a link/router down, congestion thresholds for a given link layer, trigger of a recovery mechanism such as IGP/FRR, automated network tests or probes failing). In another case, network issue detector 502 may detect an issue based on information from a (troubleshooting) bot receiving requests from a set of users, in which case the issue can be created on-the-fly, if the number/rate of requests related to (a specific type of) issue exceeds a given threshold (e.g., via a chatbot).

Once network issue detector 502 has detected an issue I, it may then determine the criticality of that issue. To that end, one option may consist in checking the number of potential users who raised a similar issue that share the same root cause according to the root causing process initiated by troubleshooting agent 506, as described below, or its LLM may also be used to determine whether the issues raised by the users have a common root cause. In other cases, an LLM may determine criticality based on the number of impacted systems or applications or the volume of affected network traffic.

Policy engine 504 is used to configure which issues identified by network issue detector 502 are eligible for LLM-based self-healing capabilities. Indeed, despite the potential power of self-healing networks, the effective use of dynamic closed-loop control is subject to debate. Consequently, some administrators are ready to adopt closed-loop control with no human in the loop wherever and whenever possible, whereas others do mandate the presence of a human to perform any action in the network, sometimes such decisions are even driven by regulations. To this end, policy engine 504 allows a network administrator to specify policies to selectively enable or disable the self-healing capabilities of the system with respect to certain types of issues.

For example, a network administrator may specify via policy engine 504 (e.g., using a user interface 518) the set of applications eligible to for self-healing resolution and/or whether a minimum number of users per application type is required to automatically trigger closed-loop control according to troubleshooting agent 506. Further constrains can be defined for governing in which parts of the network (specific sites) or on which types of devices troubleshooting agent 506 is allowed is allowed to attempt remediation actions. For example, a network administrator may allow troubleshooting agent 506 to initiate the reboot of a wireless access point, while restricting the same action on a core router or central firewall.

According to various implementations, troubleshooting agent 506 may leverage one or more LLMs to troubleshoot an issue identified by policy engine 504, find the actual root cause for the issue, and/or suggest a set of one or more actions to fix the issue. Let ai denote an action used for troubleshooting an issue I and let Ai denote an action (configuration change) on the network (closed-loop control). The set of actions Ai required to solve the issue I may be determined on-the-fly by an LLM, statically determined according to a cookbook for each trajectory made of a set of action ai, or the like. For example, a static cookbook may be used to map a specific ak to set of actions Ak,1. Consider the action ak=“Check the priority queue length of a router,” a static set of action ak,1 may be used to trigger a set of 1 action on the network (e.g., “Change the weight of the priority queue,” “Modify the WRED parameter for the high priority queue”). In another implementation, the system may discover the set of required actions related to a given root cause identified thanks to a set of action ai, using reinforcement learning or another suitable approach.

If the root cause identified for issue I is eligible for self-healing action (according to policy engine 504), troubleshooting agent 506 may perform any or all of the following:
Troubleshooting agent 506 retrieves the set of action Ai for the root cause of issue I after activating a timer T (max time to solve the issue)
Troubleshooting agent 506 may also employ various optimization criterion may be used for solving a given task T. For instance, troubleshooting agent 506 may solve some tasks with objective metrics such as reducing the processing time or improve accuracy even at the risk of involving more steps and tokens (cost). In the context of the techniques herein, the issue criticality from network issue detector 502 may also drive the optimization criteria (time versus reliability versus cost). In one implementation, the optimization criteria may be unique and decided according to policy and criticality. In another implementation, troubleshooting agent 506 may trigger multiple actions in parallel, each with different optimization criterion. For example, for a given issue I, troubleshooting agent 506 may send a request to a first LLM with a first criteria (e.g., solve as quickly as possible, optimizing time) and send the same request to a second LLM with different optimization criteria (e.g., efficiency). In such a case, troubleshooting agent 506 may use the reply to the first request (set of resolution action Ai) to quickly fix the network, followed by using the second set of actions to optimize the resolution of the issue. Note that both requests may not overlap in terms of closed-loop actions, as well.

Action analyzer 508 may assess whether the set of actions triggered by troubleshooting agent 506 have actually solved the issue. To that end several approaches may be used:
The LLM may itself ask to the users who had originally expressed some concerns whether the issue has been remediated.
The agent may check the various set of actions ai along the debugging trajectories whether the conditions that were used to identify the issues have been cleared. For example, back to the previous example, the system may check the high priority queue length and determine whether the action (change the weight) has solved the issue.

In some implementations, trajectory enhancer 510 is used to enhance the set of successful trajectories. As would be appreciated, troubleshooting agent 506 represents a complex troubleshooting and monitoring mechanism that may be based on one or more LLMs, a local database, and other components. On receiving a question, troubleshooting agent 506 may form a prompt after retrieving a set of “information” from a local database and triggers a set of actions ai (i.e., code snippet used to retrieve information from APIs, etc.) until an answer to the question is provided.

In this context, a “trajectory” refers to a set of successive actions ai triggered by troubleshooting agent 506 according to the LLM input. In some instances, trajectory enhancer 510 may use the trajectories to train one or more of the LLMs to perform similar troubleshooting tasks, stored as recipes (set of successful actions, etc.). For instance, action analyzer 508 may flag an action as successful if the answer from troubleshooting agent 506 satisfies a set of characteristics for a given (manual crafted) scenario.

In some instances, trajectory enhancer 510 may also function as a “troublemaker,” generating issues and then requesting that troubleshooting agent 506 solve them, knowing the answer to the question, beforehand. Thanks to the techniques herein, knowing whether an issue has been solved can be told by determining whether the issue has been solved (an even stronger assumption than in the case of finding a known root cause). Thus, each time the issue is solved by triggering one of more action Ai that solves the issue I, the corresponding trajectory is marked as successful and the list of action ai can be added to the database of successful trajectories.

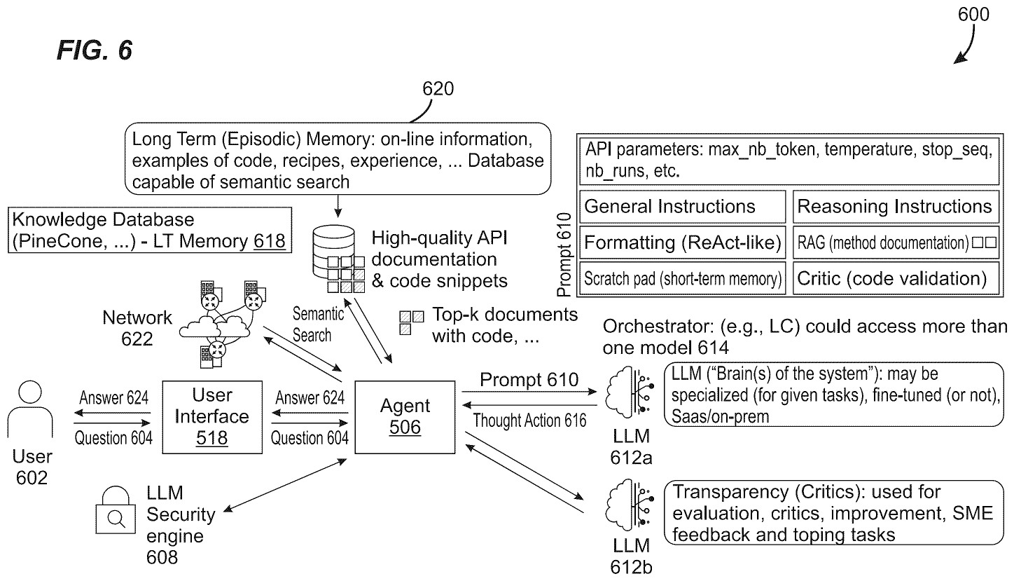

FIG. 6 illustrates an example 600 showing the operation of an LLM-based troubleshooting agent 506 performing self-healing actions in a network 622, according to various implementations. As shown, troubleshooting agent 506 may interact with one or more LLMs 612, such as LLMs 612a-612b shown, to perform self-healing actions in a network 622. These LLMs may be integrated directly into troubleshooting agent 506 or accessed by troubleshooting agent 506 remotely, such as via an API. In some implementations, each of these LLMs may have different capabilities, as well. For instance, LLM 612a may a 0-shot or model trained using Low-Rank Adaptation of LLMs (LoRA), whereas LLM 612b may be a fine-tuned model (e.g., using T5 with LoRA, knowledge distillation, etc.) with decoding lop access for constrained prompting. In some instances, troubleshooting agent 506 may also leverage an intermediary orchestrator 614 that can access one or more of the LLMs, such as LLM 612a and LLM 612b.

In further cases, LLM 612b may be a critic model that is used to critique any outputs of LLM 612a. For instance, say that LLM 612a generates code to perform a certain task or a step to complete such a task (e.g., to retrieve certain information from a network controller or other entity). In such a case, LLM 612b may assess the quality of the code (e.g., to make sure it is not missing information, correctly calls a certain method or API, is able to perform the desired task, etc.). Feedback from LLM 612b can then be fed back to LLM 612a, to enhance its operations.

Assume now that a user 602 enters a question 604 via user interface 518 regarding network 622. Note that while such input typically takes the form of a question, mere statements such as “my network connection is slow, etc.” are also equally possible inputs. In turn, troubleshooting agent 506 may seek to answer question 604 by interacting with network 622, interacting with a knowledge database 618 populated by a long term (episodic) memory 620 (e.g., by performing a semantic search for API formats, code snippets, recipes, sample use cases, or the like) using retrieval augmented generation (RAG) and/or by issuing a prompt 610 for input to any of LLMs 612. Note that prompt 610 may also indicate general instructions and/or reasoning instructions, to obtain information regarding an action 616. In some instances, an LLM security engine 608 may also oversee the actions of troubleshooting agent 506, to prevent conditions such as prompt injection attacks, etc.

In some cases, troubleshooting agent 506 may also implement action 616 in network 622. For instance, troubleshooting agent 506 may send a command to a network controller of network 622 (e.g., via an API) to reconfigure the network to address any issues. In turn, troubleshooting agent 506 may provide an answer 624 back to user interface 518 to answer question 604 (e.g., “your connection was slow because of a misconfiguration—please let us know if the issue has been resolved,” etc.).

As noted above, one fundamental issue posed by the training of LLM-powered troubleshooting agents, both in supervised and reinforcement learning settings, is the difficulty of acquiring enough ground truth labels. To address this, one approach consists in developing a set of test cases to be run against a test network. These test cases provide a ground truth that can, in turn, be used to train the agent, but they are expensive to design and implement, especially if one intends to replicate the diversity of topologies, device types, controller versions, etc. that are found in production. Test cases for factual and troubleshooting questions over a real, test network cannot just specify a static expected answer. Instead, the test cases need to specify how to solve the problem and dynamically derive the right answer by interacting with the network controllers.

Another approach consists in targeting real enterprise networks and letting network operators and end users interact directly with the agent. This allows the system to scale to a broad variety of test cases, network topologies, device types, controller versions, etc. However, in this case, no ground truth label is available.

### —Highly Interactive, Language Model-Based Network Troubleshooting Agents—

As noted above, with the help of plugins, a LLM troubleshooting and monitoring agent, such as troubleshooting agent 506, can be designed to tackle complex networking tasks such as on-demand troubleshooting, device configuration, and performance monitoring. To achieve this goal, the agent may leverage powerful LLM models (e.g., GPT-4 or the like), alongside advanced prompting techniques such as chain-of-thought (CoT) or tree-of-thoughts (ToT) prompting, to break down complex tasks into sets of intermediate steps (a plan) which are then executed one by one. For instance, when faced with solving a task such as “root cause John's poor network performance over the last 3 hours,” troubleshooting agent 506 may break down the task into the following initial troubleshooting steps:
Step 1: Identify where John is connected in the network (IP address, access device and port).
Step 2: Check the operation status of John's access interface.
Step 3: Check for any errors on John's access interface.
Step 4: Inspect the alarms logs on John's access device for any relevant issues.

After executing each step, the agent may choose to further refine or adapt its plan, by adding new steps or removing unnecessary ones. In the previous example, after running step 3, transmit errors may be identified on John's access interface, leading troubleshooting agent 506 to skip step 4 entirely and come up with additional troubleshooting steps that focus on identifying the cause of the errors (e.g., fetch the historical statistics for the access interface to see when the errors first started to appear or run a cable test to check the physical connection to user John). After all steps are executed, or a maximum step limit is reached, the agent then formulates an answer for the end user summarizing its findings.

However, it is also possible that the agent may take a considerable amount of time to perform its formulated steps, such as querying various knowledge databases, interacting with one or more LLMs, interacting with one or more network controllers (via APIs or SDKs), etc. Indeed, it may very well be on the order of minutes for the agent to return an answer to a user, when asked a certain query/question. Moreover, the amount of time needed to provide an answer may vary wildly from task to task based on their complexity, number of steps required to solve them (which may not be known a priori, as well as other environmental factors (API response times from network controllers, etc.). From the perspective of the user, this behavior is highly undesirable, as it means they are often left staring at a blank chat interface for an arbitrary amount of time before receiving any feedback, resulting in a poor user experience.

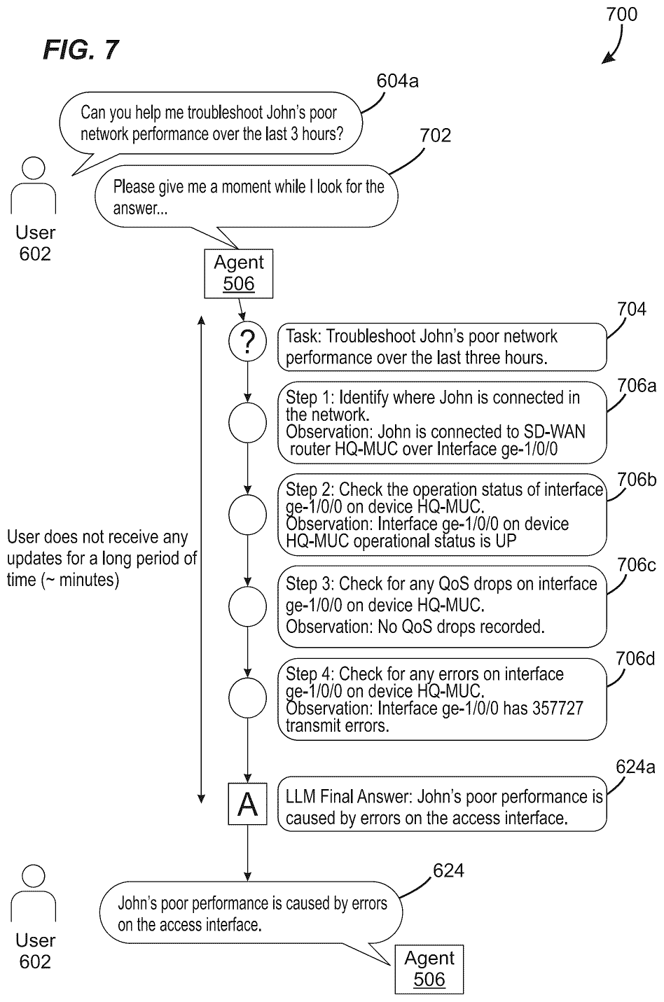

For instance, FIG. 7 illustrates an example interaction 700 between user 602 and troubleshooting agent 506. As shown, assume that end user 602 issues the question 604a, “can you please help me troubleshoot John's poor network performance over the last 3 hours?” In turn, troubleshooting agent 506 may send a confirmation 702 for display, “Please give me a moment while I look for the answer.” In addition, troubleshooting agent 506 may formulate the task 704 as “troubleshoot John's poor network performance over the last 3 hours.” Based on this task, troubleshooting agent 506 may formulate a series of steps 706a-706d.

During step 706a, troubleshooting agent 506 may seek to identify where John is connected to the network, with a step resolution/observation indicating that he is connected to SD-WAN router HQ-MUC over interface ge-1/0/0. Then, at step 706b, troubleshooting agent 506 may seek to check the status of that interface, with the resolution indicating that the interface is up. At step 706c, troubleshooting agent 506 may check for any QoS drops on the interface, with the observation that there were not. At step 706d, troubleshooting agent 506 may then check for any errors on the interface, finding that there were 357,727 transmit errors on that interface. In turn, troubleshooting agent 506 may return answer 624a, “John's poor performance is caused by errors on the access interface,” to the user interface of user 602. However, the amount of time between when user 602 issued question 604a and when troubleshooting agent 506 returned answer 624a may be on the order of minutes, which user 602 may find unacceptable, even if answer 624a was correct.

Secondly, the outcomes of the intermediate steps may also not be visible to the user, leading to situations where the users may not fully trust the end results as they may not understand how the agent arrived at the final answer. In other cases, the agent may not be able to solve the task, either because it could not identify a root cause or because it may experience some sort of an error and simply return a generic answer. For instance, consider the case in which troubleshooting agent 506 returns an answer such as any of the following examples:
“Unfortunately, I am unable to provide information on the WAN circuits used by user Ed in the last 3 hours, as all previous attempts to gather data have resulted in errors.”
“Unfortunately, I am unable to provide a list of the most recent 5 DNAC events to user Anna from the last 3 hours due to errors in the actions performed.”
Etc.

However, the information contained in the intermediate steps may provide users with valuable insights into actions or troubleshooting avenues that were explored by the agent and which were disproved as root cause for the issue at hand. Further human driven investigations around the same issue may benefit from these insights to narrow down the scope of the troubleshooting.

Thirdly, the current approach does not allow the user to contribute or provide guidance to the agent after the initial task or question is submitted or at any point during the troubleshooting process. If the user wants to provide additional guidance, they need to formulate a new task from scratch where more information is included and hence restart the entire process.

To address the above, various techniques are introduced herein that enhance a language model-based agent, such as troubleshooting agent 506, with any or all of the following functionalities:
Enabling the display of intermediate troubleshooting steps to the end user and allow to rate each step, irrespective of overall success of the question.
Allowing a user to point at a step and select an alternate troubleshooting path (from several suggested options) which the agent did not pursue.
Allowing a user to resume the LLM troubleshooting process from a particular step, with user feedback and/or additional information.

Specifically, according to various implementations, a device obtains a prompt from a user interface that requests a network troubleshooting agent complete a task with respect to a computer network using one or more language models. The device identifies, using the network troubleshooting agent, a series of steps for the network troubleshooting agent to perform in order to complete the task. The device uses the network troubleshooting agent to perform the series of steps using the one or more language models. The device provides update information to the user interface regarding performance of one or more of the series of steps by the network troubleshooting agent.

More specifically, and referring again to FIG. 5, task resolution tracker 514 may be responsible for keeping track of each question received by troubleshooting agent 506 and recording its step-by-step execution. To achieve this goal, task resolution tracker 514 may obtain a copy of the messages exchanged between troubleshooting agent 506 and any of the LLMs or other language models that it uses to solve various tasks (e.g., planning, code generation, etc.) as well as the API interactions (e.g., requests, responses, etc.) with various network controllers. For each step in the task resolution process, task resolution tracker 514 may keep track any or all of the following data:
Question ID: unique question identifier
Step ID: unique step identifier
Previous step id: the id of the step executed before.
Next step ID: the id of the step executed next.
Step Type:
   Primary: primary steps are part of the main task resolution path and are considered by the LLM model to be the most likely path towards successful resolution of the issue.
   Alternate: a set of alternate troubleshooting steps may be generated during the planning phase (or plan updates) that allow the exploration of alternative troubleshooting paths. These steps are not automatically executed by the agent but can be triggered on demand by an end user.
   User suggested: a step that was added to the task resolution plan based on end user input.
Execution status:
   Planned: step is part of the plan but has not been executed yet.
   In-Progress: step is currently executed.
   Completed: step execution has completed.
   Skipped: a step that was part of the primary execution plan but was later skipped as it was no longer necessary.
      LLM Prompt(s): The LLM prompts used to trigger the execution of the step.
      LLM Response: either a plan or code snippet that needs to be executed or an observation.
      API Requests and Responses: records details about the data retrieved from the network.
      User feedback: This can take the form of a 1 to 5 score, a binary thumbs up/down, or the like.
      Summary: For steps other than those in completed state, the summary may take the form of a simple sentence explaining the overall intent (e.g.: “Check errors on device hq-muc-01 interface gi-0/0/0.”) and can be derived directly from the LLM model planning output. Once the step is completed, the summary may be amended with the LLM model observation detailing the outcome of the step (e.g.: “No errors were found” or “Found 3590154 transmit errors.”).

In various implementations, task resolution tracker 514 assembles all the steps that belong to a specific task or question in the form of a directed graph. In a simple case, the graph is a tree. In some instances, the graph may also be a directed graph (e.g., if multiple steps are explored in parallel, and their results are then joined back to continue the troubleshooting flow). Each time a particular step is completed, or the overall troubleshooting plan is revised, the contents of the graph are also updated to reflect the change with existing nodes marked as completed or skipped and new nodes potentially being added. Any change in the overall task execution progress may also be published to downstream components such as user interface 518 which further propagates the information to the end user, as detailed further below.

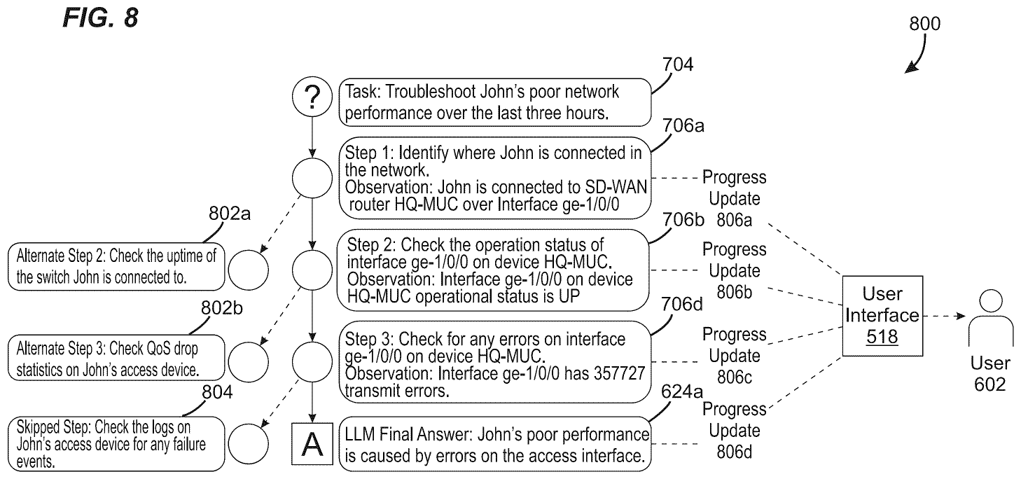

FIG. 8 illustrates an example execution graph 800 for an LLM-based network troubleshooting agent such as troubleshooting agent 506, in various implementations. As shown, graph 800 may capture task 704 extracted by troubleshooting agent 506 from the input question (e.g., question 604a). Subsequent nodes in the directed graph may indicate the steps that troubleshooting agent 506 performs during its efforts to generate an answer, such as answer 624. For instance, nodes in execution graph 800 may indicate that troubleshooting agent 506 performed step 706a, then step 706b, and then step 706d.

Associated with any of these nodes may also be alternative or skipped steps that troubleshooting agent 506 also considered. For instance, rather than performing step 706a, troubleshooting agent 506 may consider performing step 802a in the alternate, such as checking the uptime of the switch to which user John is connected. Similarly, rather than performing step 706b, troubleshooting agent 506 may consider alternatively performing step 802b, such as checking QoS drop statistics on the access device of John. In addition, execution graph 800 may also include a node that indicates that troubleshooting agent 506 skilled performance of step 804 (e.g., step 706c in FIG. 7), which entails checking the logs on the access device for any failure events.

Also as shown, in some implementations, troubleshooting agent 506 may also provide progress updates to user interface 518 for review by user 602. For instances, progress updates 806a-806d may indicate the steps that troubleshooting agent 506 is taking to arrive at an answer, as well as its eventual answer 624a.

It is worth noting that some exchanges between troubleshooting agent 506 and its language models or other lower-level components may not trigger any end user updates. For instance, steps related to the LLM model correcting errors encountered during code execution, or iterative searches of Knowledge Databases for API or SDK documentation may not provide any useful information to an end user.

Referring again to FIG. 5, user collaboration module 516 may be responsible for incorporating user feedback into the troubleshooting workflow of troubleshooting agent 506. User feedback, collected via user interface 518 may take various forms such as any or all of the following:
A request to resume the task resolution process from a particular step while including additional information. For instance, a user may request that instead of looking at interface errors for the last 3 hours, the step is repeated with a 24-hour timespan.
A request to explore a given alternate path of the troubleshooting workflow such that more comprehensive troubleshooting is achieved.
A request to resume the task resolution process from a particular step while adding additional user suggested steps. For instance, in addition to checking interface errors, a user may request the inclusion of a step that checks for QoS drops or counters related to Pause Frames.

Regardless of the feedback type, the user may be required to indicate a step (primary or alternate) from which they would like the task resolution process to be resumed, in some implementations. User collaboration module 516 may then use this information to retrieve the LLM prompt associated with the step from task resolution tracker 514 and makes the updates indicated by the user before triggering troubleshooting agent 506 to resume the processes.

In one implementation, user collaboration module 516 may perform the prompt updates using predefined static rules that allow editing or replicating certain parts of the initial prompt text. In another implementation, user collaboration module 516 itself may leverage an LLM model to incorporate the user changes and generate an updated prompt message.

In various implementations, user collaboration module 516 may communicate with user interface 518, to allow a user to interact with the system, such as by asking questions and providing feedback on the progress of each step performed by troubleshooting agent 506. By default, the user may receive only a summary of each step that highlight the overall goal of the step and its outcome (observation), however the user may also use user interface 518 to review more detailed information such as a list of API calls made as part of the step, as well as the raw data collected from the network.

In further implementations, user collaboration module 516 may also allow the user to interact with troubleshooting agent 506 via user interface 518 and resume the LLM troubleshooting process from a particular step, while providing feedback and/or additional information, or even select alternate troubleshooting paths that should be explored.

In some cases, user collaboration module 516 may also allow the user to specify, via user interface 518 how useful each step is in the troubleshooting workflow of troubleshooting agent 506. In such a case, agent training module 512 may use this information as part of a reinforcement learning mechanism with respect to troubleshooting agent 506, thereby improving its operations over time.

As would be appreciated, the particular form of user interface 518 can vary, such as a classic chatbot integrated into a collaboration tool such as Webex or the like, a standalone user interface, or integrated into other existing systems or tools, allowing for a richer user experience. In the case of a chatbot, user collaboration module 516 may periodically provide updates via chat messages and controller the troubleshooting workflow using natural language commands. In the case of a dedicated user interface, a more feature rich user experience may be employed, such as by user collaboration module 516 presenting the user with a step-by-step execution graph that the user can interact with dynamically.

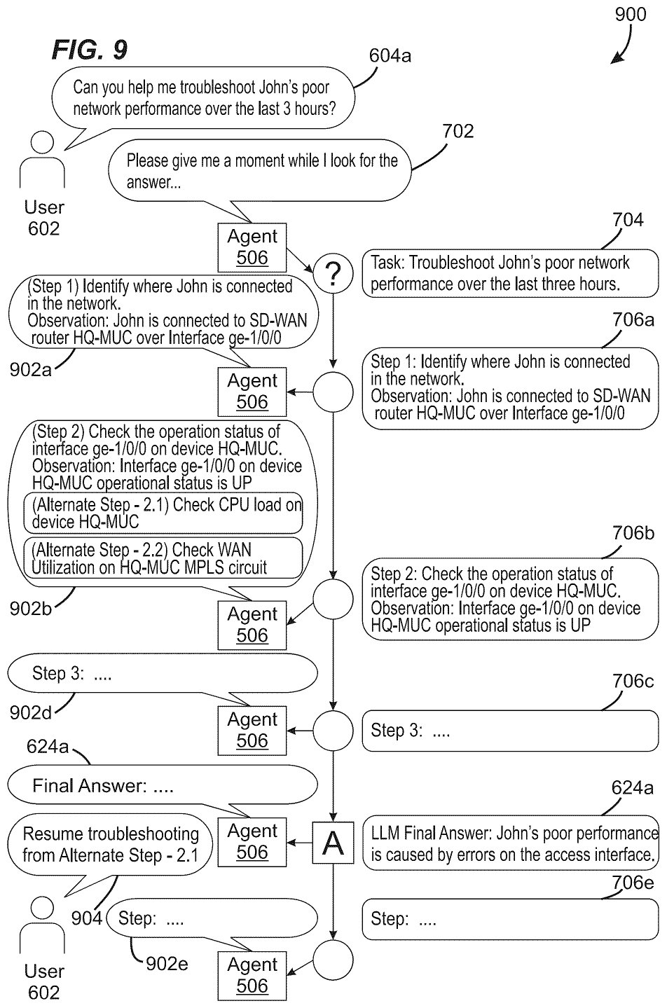

FIG. 9 illustrates an example 900 of an LLM-based network troubleshooting agent that allows user collaboration to generate an answer. Continuing the previous examples in FIGS. 7-8, assume again that user 602 issues question 604a, leading troubleshooting agent 506 to formulate task 704 and provide confirmation 702 back to user 602. From task 704, troubleshooting agent 506 may first perform step 706a. Then, troubleshooting agent 506 may provide, via user collaboration module 516, update information 902a for review by user 602. As shown, information 902a may include information as to step 706a performed by troubleshooting agent 506, as well as information regarding the outcome/observation that resulted.

Also as shown, after performing step 706b, the system may return information 902b indicative of step 706b performed by troubleshooting agent 506 and its outcome/observation that resulted. In addition, update information 902b may also include a listing of the alternative steps that troubleshooting agent 506 considered performing instead of step 706b. Doing so gives user 602 not only insight into the workflow of steps that troubleshooting agent 506 actually performs, but also greater insight into the steps that it could have performed but opted against performing. This process may continue thereby updating user 602 for each of the steps that policy engine 504 performs (e.g., providing update information 902d regarding step 706d, etc.), before finally returning answer 624a to user 602.

In various implementations, as shown, user 602 may then input request 904, asking troubleshooting agent 506 to perform one of the alternate steps indicated in information 902b. In turn, troubleshooting agent 506 may perform step 706e, which is the alternate step indicated in may then input request 904. Troubleshooting agent 506 may then return update information 902e indicative of step 706e and its resulting observations.

In further implementations, the system may also give user 602 the possibility to ask arbitrary questions about the process. In such a case, troubleshooting agent 506 may asynchronously handle those requests and prompts an LLM (either the same as the one used for troubleshooting or a different one) to obtain a reply: the prompt includes the user's question and details about the steps taken by the agent so far. For instance, the user may ask “Did you think of checking whether feature X is enabled on the switch?” The LLM may then survey the step performed so far and reply “Yes, it is currently enabled.” or “No, that's a good idea, let me try this soon.” The prompt may request the LLM to produce two outputs: 1.) a user-facing response (e.g., “No, that's a good idea, let me try this soon”) and 2.) an agent-facing hint (e.g., “Suggestion for next step: verify if feature X is enabled on the switch”), which is inserted in the planning prompt afterwards. This workflow allows a seamless collaboration between the user (especially if it is a support engineer or a power user) and the agent in solving the initial question.

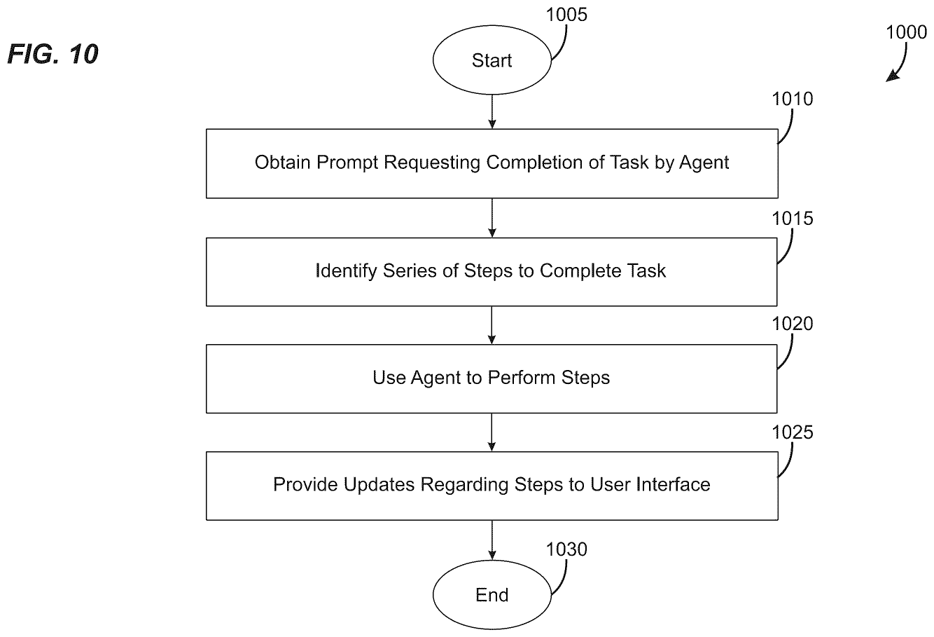

FIG. 10 illustrates an example simplified procedure 1000 (e.g., a method) for providing a highly interactive, language model-based network troubleshooting agent, in accordance with one or more implementations described herein. For example, a non-generic, specifically configured device (e.g., device 200), such as a router, firewall, controller for a network (e.g., an SDN controller or other device in communication therewith), server, or the like, may perform procedure 1000 by executing stored instructions (e.g., language model process 249 and/or network control process 248). The procedure 1000 may start at step 1005, and continues to step 1010, where, as described in greater detail above, the device may obtain a prompt from a user interface that requests a network troubleshooting agent complete a task with respect to a computer network using one or more language models. In various implementations, the one or more language models include at least one a large language model (LLM). In some cases, the task corresponds to determining a root cause of a condition in the computer network.

At step 1015, as detailed above, the device may identify, using the network troubleshooting agent, a series of steps for the network troubleshooting agent to perform in order to complete the task.

At step 1020, the device may use the network troubleshooting agent to perform the series of steps using the one or more language models, as described in greater detail above. In various instances, the network troubleshooting agent uses the one or more language models to generate code to perform a particular one of the series of steps in the computer network.

At step 1025, as detailed above, the device may provide update information to the user interface regarding performance of one or more of the series of steps by the network troubleshooting agent. In various implementations, the series of steps in response to input from the user interface, after performance of at least one step in the series of steps. In some cases, the update information for a particular step in the series of steps indicates an alternate step that the network troubleshooting agent could have performed; and wherein the input from the user interface comprises a request that the network troubleshooting agent perform the alternate step. In further cases, the input from the user interface comprises a query regarding the series of steps. In various implementations, the update information for a particular step indicates a skipped step from the series of steps. In one implementation, the device provides the update information in part by maintaining a directed graph that represents the series of steps. The device may also provide an answer to the user interface for the prompt.

Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for highly interactive, language model-based network troubleshooting agents, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
obtaining, by a device, a prompt from a user interface that requests a network troubleshooting agent complete a task with respect to a computer network using one or more language models;
identifying, by the device and using the network troubleshooting agent, a series of steps for the network troubleshooting agent to perform in order to complete the task;
using, by the device, the network troubleshooting agent to perform the series of steps using the one or more language models; and
providing, by the device, update information to the user interface regarding performance of one or more of the series of steps by the network troubleshooting agent.

2. The method as in claim 1, wherein the one or more language models include at least one a large language model (LLM).

3. The method as in claim 1, wherein the task corresponds to determining a root cause of a condition in the computer network.

4. The method as in claim 1, wherein the network troubleshooting agent uses the one or more language models to generate code to perform a particular one of the series of steps in the computer network.

5. The method as in claim 1, further comprising:
updating, by the device, the series of steps in response to input from the user interface, after performance of at least one step in the series of steps.

6. The method as in claim 5, wherein the update information for a particular step in the series of steps indicates an alternate step that the network troubleshooting agent could have performed; and wherein the input from the user interface comprises a request that the network troubleshooting agent perform the alternate step.

7. The method as in claim 5, wherein the input from the user interface comprises a query regarding the series of steps.

8. The method as in claim 1, wherein the update information for a particular step indicates a skipped step from the series of steps.

9. The method as in claim 1, wherein the device provides the update information in part by maintaining a directed graph that represents the series of steps.

10. The method as in claim 1, further comprising:
providing an answer to the user interface for the prompt.

11. An apparatus, comprising:
one or more network interfaces;
a processor coupled to the one or more network interfaces and configured to execute one or more processes; and
a memory configured to store a process that is executable by the processor, the process when executed configured to:
obtain a prompt from a user interface that requests a network troubleshooting agent complete a task with respect to a computer network using one or more language models;
identify, using the network troubleshooting agent, a series of steps for the network troubleshooting agent to perform in order to complete the task;
use the network troubleshooting agent to perform the series of steps using the one or more language models; and
provide update information to the user interface regarding performance of one or more of the series of steps by the network troubleshooting agent.

12. The apparatus as in claim 11, wherein the one or more language models include at least one a large language model (LLM).

13. The apparatus as in claim 11, wherein the task corresponds to determining a root cause of a condition in the computer network.

14. The apparatus as in claim 11, wherein the network troubleshooting agent uses the one or more language models to generate code to perform a particular one of the series of steps in the computer network.

15. The apparatus as in claim 11, wherein the process when executed is further configured to:
update the series of steps in response to input from the user interface, after performance of at least one step in the series of steps.

16. The apparatus as in claim 15, wherein the update information for a particular step in the series of steps indicates an alternate step that the network troubleshooting agent could have performed; and wherein the input from the user interface comprises a request that the network troubleshooting agent perform the alternate step.

17. The apparatus as in claim 15, wherein the input from the user interface comprises a query regarding the series of steps.

18. The apparatus as in claim 11, wherein the update information for a particular step indicates a skipped step from the series of steps.

19. The apparatus as in claim 11, wherein the apparatus provides the update information in part by maintaining a directed graph that represents the series of steps.

20. A tangible, non-transitory, computer-readable medium storing program instructions that cause a device to execute a process comprising:
obtaining, by the device, a prompt from a user interface that requests a network troubleshooting agent complete a task with respect to a computer network using one or more language models;
identifying, by the device and using the network troubleshooting agent, a series of steps for the network troubleshooting agent to perform in order to complete the task;
using, by the device, the network troubleshooting agent to perform the series of steps using the one or more language models; and
providing, by the device, update information to the user interface regarding performance of one or more of the series of steps by the network troubleshooting agent.
